(19) United States
(12) Patent Application Publication
(10) Pub. No.: US 2025/0196556 A1
(43) Pub. Date: Jun. 19, 2025

(54) AIR SPRING WITH A GAITER VENT

(71) Applicant: Continental Automotive Technologies GmbH, Hannover (DE)

(72) Inventor: Dragos Buzoianu, Sibiu (RO)

(73) Assignee: Continental Automotive Technologies GmbH, Hannover (DE)

(21) Appl. No.: 18/979,689

(22) Filed: Dec. 13, 2024

(30) Foreign Application Priority Data
Dec. 13, 2023 (EP) 23465570.2
Dec. 14, 2023 (DE) 10 2023 212 650.8

(51) Int. Cl. B60G 11/27

(52) U.S. Cl. CPC B60G 11/27; B60G 2202/152; B60G 2204/126; B60G 2206/42; B60G 2800/162

(57) ABSTRACT

An air spring for a motor vehicle comprises a first and second attachment part. An elastomeric rolling lobe is fastened in a pressure-tight manner between the two attachment parts, whereby a volume-elastic pressure chamber is delimited. The first attachment part being rotationally movably mounted via a torsion bearing ring with respect to a connector part of the motor vehicle. The torsion bearing ring for rotationally movable mounting is arranged between a bearing seat ring connected to the connector part of the motor vehicle, and the first connector part. A gaiter being is to the two connector parts to protect the rolling lobe from contamination. The gaiter delimits a varying-volume space which surrounds the rolling lobe. A ventilation path for ventilation of the gaiter leads from the surroundings of the air spring through the bearing seat ring and through the first attachment part into the space surrounded by the gaiter.

### TECHNICAL FIELD

The invention relates to an air spring for a motor vehicle.

### BACKGROUND

Air springs or air spring struts, which are braced between a chassis and a body of a motor vehicle and which have a rolling lobe which in turn is fastened between a cover and a rolling piston, are known in a large number of embodiments. During operation, the air spring is subjected to an internal positive pressure, and the rolling lobe rolls during spring movements on the outer surface of the concentric rolling piston, with a rolling fold being formed. To limit expansion, the rolling lobe is surrounded by a sleeve-shaped outer guide.

Prior art has disclosed an air spring strut for a motor vehicle, in which the rolling lobe, in particular its rolling fold, is protected from contamination by a gaiter, wherein the gaiter is attached firstly to a lower end of the outer guide and secondly to a support means for the rolling piston. Due to the spring movement of the air spring, the volume of the space surrounded by the gaiter changes, with the result that a vacuum can arise in this space, which could implode or damage the gaiter. Therefore, the air trapped by the gaiter must be replaced with the ambient air, which, however, has dirt particles. The replacement allows these dirt particles to enter the interior of the gaiter space, damaging the rolling fold. For this reason, a ventilation channel is provided in the support means, which connects the surroundings to the gaiter space. The ventilation channel allows air from the outside to enter the gaiter space and also to flow out again. As a result, there is no negative pressure in the gaiter space during compression and rebound movements of the air spring strut.

### SUMMARY

The object is to provide an air spring for a motor vehicle, in which a further type of ventilation of the space delimited by the gaiter is specified.

The air spring is used in an air spring system of a motor vehicle.

### BRIEF DESCRIPTION OF THE DRAWINGS

Embodiments result from the following description of one exemplary embodiment with reference to the figures.

In the figures:

FIG. 1 shows an air spring according to the example,

FIG. 2 shows a bearing seat ring for the air spring, and

FIG. 3 shows a lower part of the bearing seat ring.

### DETAILED DESCRIPTION

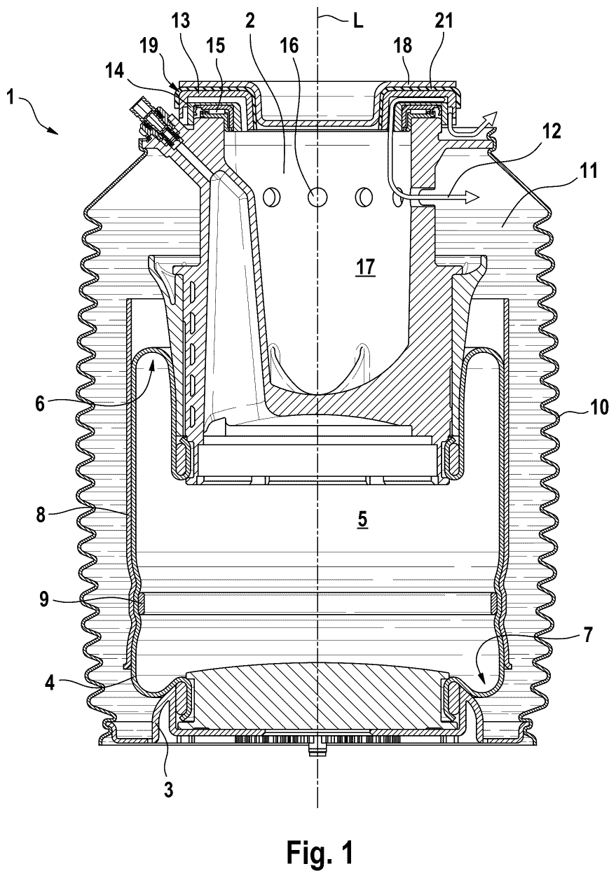

FIG. 1 shows an air spring 1 according to the example with its essential components. A rolling piston 2 serves as first connector part to connect to the vehicle body. A cover 3 serves as second connector part for connecting to a wheel support. The air spring 1 shown here is in what is known as the “upside-down position”. The longitudinal axis of the air spring 1 is marked with L.

A rolling lobe 4, which is clamped in a pressure-tight manner between the rolling piston 2 and the cover 3, delimits, with these connector parts, a pressure chamber 5 filled with compressed air with an elastic volume. A tubular rolling lobe 4 is attached with a first end to the rolling piston 2 and with a second end to the cover 3. The fastening of the rolling lobe ends can either be carried out by vulcanization to the connector parts 2, 3, or the rolling lobe ends are pressed in with clamping rings at corresponding clamping bases of the connector parts 2, 3. In addition, the rolling lobe 4 rolls on the rolling piston 2, with a rolling fold 6 being formed. A further fold 7 is formed on the cover 3. The rolling lobe 4 is provided with strength supports which run in the cross and/or axial direction.

Furthermore, the air spring 1 is rotationally movably connected via a torsion bearing 15 to a fastening portion of the vehicle body or the wheel support of the motor vehicle. In the present example, this fastening portion is a connector part 18 of the vehicle body. A bearing seat ring 19 is pressed in concentrically below the connector part 18. In turn, a torsion bearing 15 has passed into the bearing seat ring 19, on which the rolling piston 2 is supported for rotationally movable mounting. The torsion bearing 15 is designed, according to the example, as a roller bearing. It is arranged in the axial direction between the bearing seat ring 19 and the rolling piston 2. As a result, the rolling piston 2 is rotationally movably mounted in relation to the connector part 18. In order to reduce the entry of vibrations into the vehicle body, a vibration damping element 21 is provided which is arranged between the connector part 18 and the bearing seat ring 19.

The air spring 1 shown in FIG. 1 is in the pressure-filled and operational state. Thus, the rolling lobe 4 is at least partially enclosed by a sleeve-shaped outer guide 8. The outer guide 8 is attached to the rolling lobe 4 by means of a clamping ring 9 located in the pressure chamber 5. The outer guide 8 serves as a support corset and limits the lateral expansion of the rolling lobe 4. The rolling lobe 4 bears essentially with its outer side against the inner side of the outer guide 8, wherein the rolling fold 6 and the fold 7 are exposed in the normal position.

A gaiter 10 is provided to protect the rolling fold 6 and the fold 7 from contamination and damage. The gaiter 10 is attached firstly to the rolling piston 2 and secondly to the cover 3. The respective gaiter ends are fastened via a positively locking connection to an outward-facing collar of the respective connector part. Thus, the gaiter 10 delineates a space 15 from the rolling lobe 4, the rolling piston 2 and the cover 3. This space 15 varies in volume as the air spring 1 compresses and rebounds, which is why it must be ventilated.

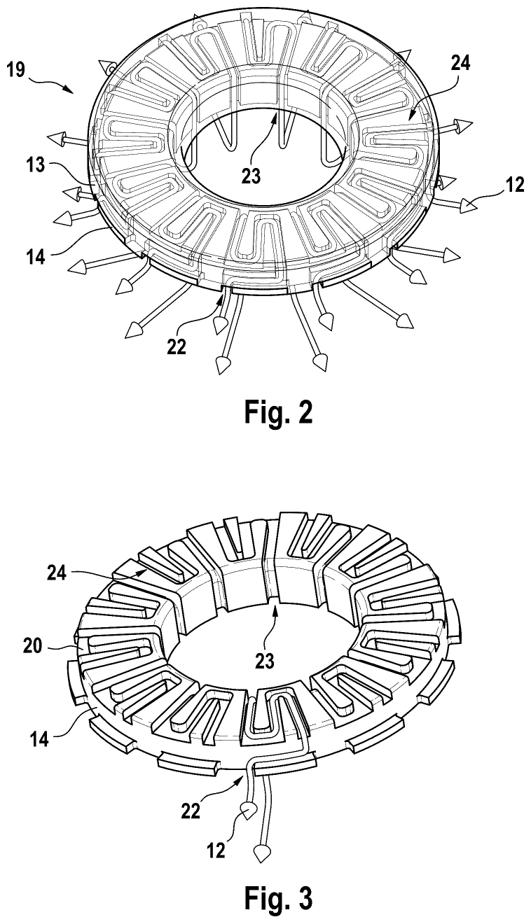

Thus, according to the example, a ventilation path 12 is provided, which leads from the surroundings of the air spring 1 via the bearing seat ring 19 and the rolling piston 2 in the space 15 of the gaiter 10. This ventilation path 12 is realized in that one or more channels are made in the bearing seat ring 19, which channels open into a cavity 17 of the rolling piston 2, and one or more openings 16 are made in the rolling piston, which openings establish a connection to the space 15 of the gaiter 10. Thus, a number of openings 16 are made in the circumferential direction in a hollow-cylindrical portion of the rolling piston 2, which represents the cavity 17. The channels in the bearing seat ring 19 are described using FIGS. 2 and 3.

FIG. 2 shows the bearing seat ring 19 comprising a first part 13 and a second part 14. The first part 14 is shown transparently so that the ventilation paths 12 can be seen. Ventilation paths 12 are namely shown essentially by a plurality of channels 20 in the second part 14, as can be gathered from FIG. 3. The second part 14 is designed in such a way that a plurality of channels 20 with respective inlet orifices 22 and outlet orifices 23 are realized. Each of the channels 20 comprises an inlet orifice 22 which is formed radially outside on the second part 14 and an outlet orifice 23 which is formed axially inside on the part 14. From a respective inlet orifice 22, the channel 20 is formed by a meandering portion 24 toward the outlet orifice 23. The meandering portion 24 runs inward, outward and inward once again. This makes it more difficult for dirt particles to pass into the interior. For ease of implementation, channels 20 are simply made in the top of the second part 14 and are closed in a cover-like manner by the first part.

1. An air spring for a motor vehicle comprising:
a first attachment part and a second attachment part;
an elastomeric rolling lobe fastened in a pressure-tight manner between the two attachment parts to the latter, whereby a volume-elastic pressure chamber is delimited;
a torsion bearing ring for rotationally movably mounting the first attachment part with respect to a connector part of the motor vehicle;
a bearing seat ring connected to the connector part of the motor vehicle, wherein the torsion bearing ring is arranged between the bearing seat ring and the first connector part;
a gaiter connected to the two connector parts, wherein the gaiter delimits a varying-volume space which surrounds the rolling lobe whereby the rolling lobe is protected from contamination by the gaiter; and
a ventilation path for ventilation of the gaiter leads from the surroundings of the air spring through the bearing seat ring and through the first attachment part into the space surrounded by the gaiter.

2. The air spring as claimed in claim 1, wherein the bearing seat ring comprises at least one channel.

3. The air spring as claimed in claim 1, wherein the bearing seat ring comprises a first part which bears against the connector part of the motor vehicle and a second part which bears against the torsion bearing ring.

4. The air spring as claimed in claim 2, wherein the at least one is made in the second part, and the first part rests in a cover-like manner on the second part.

5. The air spring as claimed in one of claim 2, wherein the at least one channel comprises a respective inlet orifice, which is provided on the outside on the second part, and a respective outlet orifice, which is provided on the inside on the part.

6. The air spring as claimed in claim 5, wherein the at least one channel comprises a respective meandering portion from the respective inlet orifice to the respective outlet orifice.

7. The air spring as claimed in one of claim 2, wherein the first connector part comprises a cavity into which the at least one channel of the bearing seat ring leads.

8. The air spring as claimed in claim 1, wherein at least one opening is made in a wall of the cavity of the first connector part, which leads into the space of the gaiter.
